(19) United States
(12) Patent Application Publication
(10) Pub. No.: US 2002/0052808 A1
(43) Pub. Date: May 2, 2002

(54) Book management apparatus

(76) Inventors: Hiroyuki Sekihata, Miyagi (JP); Sayaka Watanabe, Miyagi (JP)

Correspondence Address: STAAS & HALSEY LLP, 700 11TH STREET, NW, SUITE 500, WASHINGTON, DC, 20001, US

(21) Appl. No.: 09/803,996

(22) Filed: Mar. 13, 2001

(30) Foreign Application Priority Data
Oct. 31, 2000 (JP) 2000-332319

(51) Int. Cl. G06F 17/60

(52) U.S. Cl. 705/28

(57) ABSTRACT

A book management apparatus capable of relieving librarians at individual libraries of repetitious work. When an order for books has been placed by a library management system, ordering information management means of the book management apparatus receives and manages the ordering information. On a predetermined closing day, ordering means places an order for books with a wholesaler management system at prices reduced in accordance with the numbers of copies ordered for identical books, while looking up the ordering information managed by the ordering information management means. Bibliographic information management means acquires bibliographic information about the ordered books from the wholesaler management system and manages the acquired information. When the ordered books have been delivered to the library, book stock information management means registers the books as possessions of the library. When books are loaned between libraries, loan information management means manages the status of loan for each library.

### BACKGROUND OF THE INVENTION

(1) Field of the Invention

The present invention relates to a book management apparatus, and more particularly, to a book management apparatus for managing book stocks of a plurality of libraries through a network.

(2) Description of the Related Art

With recent computerization of libraries, more and more libraries are beginning to manage the loan or lending/borrowing of books by a computer system. Also, quite a few libraries use a computer system not only for the management of the loan of books but also for the registration of bibliographic information (e.g., information on titles, authors, publishers, etc.) as attributes of books, to provide service whereby information can be freely retrieved by using keywords.

With such conventional systems, it is necessary that individual libraries should separately register and manage the bibliographic information on their own book stock. Accordingly, even in the case where some books kept in a library are owned also by other libraries, they must be registered separately in the individual libraries, thus requiring redundant registration operations.

Also, libraries are generally put under the control of respective administrations and there is a limit to the number of books that each library can purchase or manage within the budget. Consequently, a library in a small administrative district may fail to fully meet the needs of users as to the number of possessed books etc.

FIG. 35 illustrates a conventional book ordering procedure conducted between a library and a wholesaler.

In the figure, libraries 1 to 3 have respective library management systems 1a to 3a for management of their own book stocks. A book wholesaler 4 has a wholesaler management system 4a for managing book ordering data and bibliographic information.

When placing an order for new books in such a conventional system, the library 1 first sends a purchase order 5a or ordering data 5b to the wholesaler 4 by mail or the like.

The wholesaler 4 registers the purchase order 5a or ordering data 5b in the wholesaler management system 4a and also places an order with a bookbinder, not shown, for the corresponding books.

When supplied with the ordered books from the bookbinder, the wholesaler 4 first delivers the books 6a to the orderer, that is, the library 1. Subsequently, the wholesaler stores bibliographic information about the newly delivered books in a CD-ROM 6c or a floppy disk 6b, which is then delivered to the library 1 at regular intervals (e.g., once a month).

In the library 1 thus supplied with the bibliographic information, the bibliographic information is registered in the library management system 1a, so that the new books can be made open to access.

Thus, according to the conventional procedure, it is necessary that each library produce purchase orders or ordering data and send them to the wholesaler 4 by mail or the like, and also that the wholesaler 4 register the purchase orders etc. in its wholesaler management system 4a, thus requiring complicated and labor-consuming work.

Also, the bibliographic information is supplied from the wholesaler 4 only periodically, as stated above. A problem therefore arises in that, even if books have already arrived, they cannot be made open to access until the bibliographic information reaches.

Conventionally, moreover, a librarian, who is a member of library staff, selects books to be newly purchased, while making reference, for example, to book reviews in newspapers etc. Accordingly, the lines of books kept in a library are influenced by the librarian's subjective point of view, giving rise to a problem that the library may fail to be furnished with books needed by users.

### SUMMARY OF THE INVENTION

The present invention was created in view of the above circumstances, and an object thereof is to provide a book management apparatus which enables individual libraries to easily and quickly manage their book stocks as well as to perform an ordering process at low cost.

Another object of the present invention is to provide a book management apparatus which makes it possible to order books that fully reflect users' needs and which also permits the books to be made open to access in a short period of time after ordering.

To achieve the above objects, there is provided a book management apparatus for managing book stocks of a plurality of libraries through a network. The book management apparatus comprises book stock information management means for managing book stock information which is information about book stocks of individual libraries, bibliographic information management means for managing bibliographic information comprising attributes of books managed by the book stock information management means, and loan information management means for managing loan information about loan of the book stocks of the individual libraries.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principle of operation according to the present invention;

FIG. 2 is a diagram showing an exemplary configuration according to an embodiment of the present invention;

FIG. 3 is a diagram exemplifying a detailed configuration of a library system server appearing in FIG. 2;

FIG. 4 is a diagram exemplifying a detailed configuration of a wholesaler-side server appearing in FIG. 2;

FIG. 5 is a diagram showing an example of a book selection screen which allows selection of books when new books are to be ordered;

FIG. 6 is a diagram showing an example of data stored in a bibliography DB;

FIG. 7 is a diagram showing an example of a book selection screen which allows selection of books from ordering data;

FIG. 8 is a diagram showing an example of data stored in a received/placed order DB;

FIG. 9 is a diagram showing an example of a book selection screen which allows selection of books from statistical data;

FIG. 10 is a diagram showing an example of data stored in a best reader DB;

FIG. 11 is a diagram showing an example of a book selection screen which allows selection of books from newly published books;

FIG. 12 is an exemplary table showing the relationship between the number of copies ordered and discount rate;

FIG. 13 is an exemplary graph showing the relationship between the number of copies ordered and discount rate;

FIG. 14 is a diagram of an exemplary screen showing a list of ordered books;

FIG. 15 is a diagram showing how received/placed order data changes after a “Confirm Order” button is operated in the screen shown in FIG. 12;

FIG. 16 shows a mail message notifying a staff member of a library that an order has been accepted;

FIG. 17 is a diagram showing how the bibliography DB and a possession DB are correlated with regard to ordered books;

FIG. 18 is a diagram showing how possession data changes when a collating process is executed at a library;

FIG. 19 is a diagram showing an exemplary screen for searching bibliographic data by a keyword;

FIG. 20 is a diagram showing an exemplary screen in which is displayed the result of search by the keyword input in the search screen shown in FIG. 19;

FIG. 21 is a diagram showing an exemplary screen for registering an SDI keyword;

FIG. 22 shows an example of an electronic mail message notifying the results of search by the SDI keyword registered in the screen shown in FIG. 21;

FIG. 23 shows an exemplary screen displayed when hot text “Waiting for Arrival” has been operated in the electronic mail message shown in FIG. 22;

FIG. 24 is a diagram illustrating an exemplary method for generalizing book codes used in a plurality of libraries;

FIG. 25 is a chart showing an example of generalized book codes;

FIG. 26 is a diagram showing change of the possession DB in response to interlibrary lending when books are lent from a library A to a library B;

FIG. 27 is a diagram showing change of the possession DB in response to interlibrary lending when the library B has received the books from the library A;

FIG. 28 shows exemplary data stored in an interlibrary loan data area when the library B has lent the borrowed books to users;

FIG. 29 shows exemplary data stored in the interlibrary loan data area when the users have returned the borrowed books to the library B;

FIG. 30 is a diagram showing change of the possession DB in response to interlibrary lending when the library B has returned the borrowed books to the library A;

FIG. 31 is a flowchart illustrating an example of a process executed by the library system server when ordering books from a book selection screen;

FIG. 32 is a flowchart illustrating an example of a process executed by the library system server on an order closing day;

FIG. 33 is a flowchart illustrating an example of a process executed when an SDI keyword is registered;

FIG. 34 is a flowchart illustrating an example of a process executed when new books have been registered; and

FIG. 35 is a diagram showing a conventional book ordering procedure conducted between a library and a wholesaler.

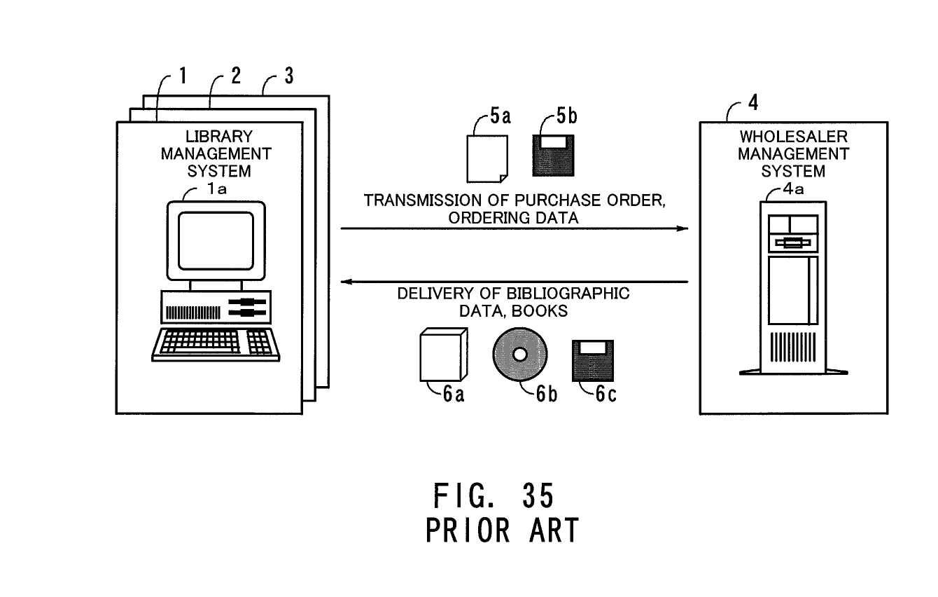

### DESCRIPTION OF THE PREFERRED EMBODIMENTS

An embodiment of the present invention will be hereinafter described with reference to the drawings.

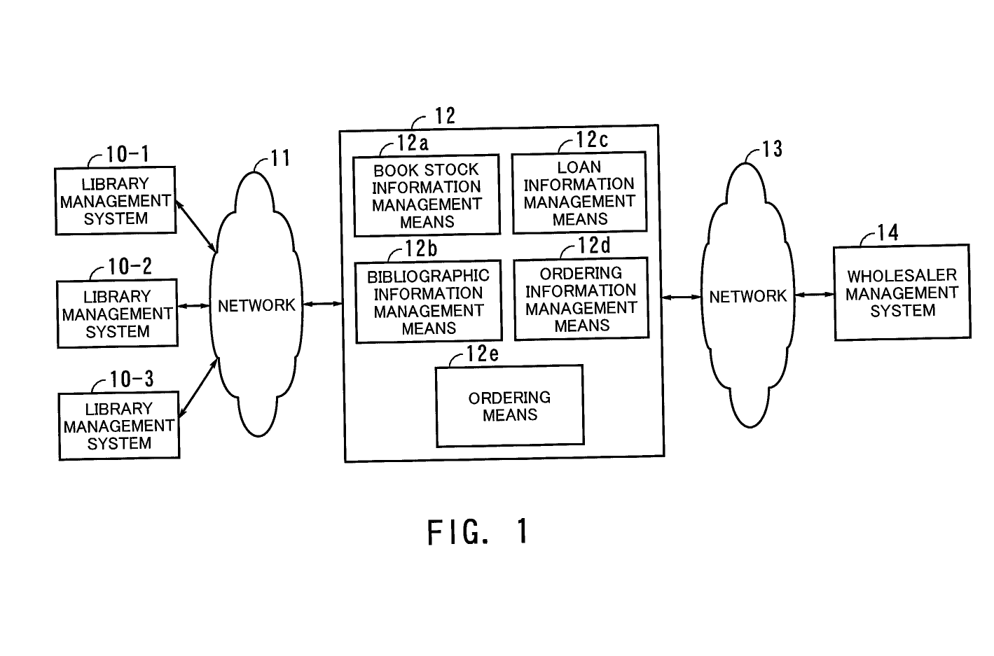

FIG. 1 illustrates the principle of operation according to the present invention. In the figure, a book management apparatus 12 according to the present invention comprises book stock information management means 12a, bibliographic information management means 12b, loan information management means 12c, ordering information management means 12d, and ordering means 12e. The apparatus 12 is connected to library management systems 10-1 to 10-3 through a network 11, as well as to a wholesaler management system 14 through a network 13.

The book stock information management means 12a manages book stock information which is information about the book stocks of individual libraries having the library management systems 10-1 to 10-3, respectively.

The bibliographic information management means 12b manages bibliographic information which comprises attributes of books managed by the book stock information management means 12a.

The loan information management means 12c manages loan information about the loan of the book stocks of the individual libraries.

The ordering information management means 12d receives information about ordering of new books from the individual libraries and manages the ordering information.

Based on the ordering information managed by the ordering information management means 12d, the ordering means 12e places an order with the wholesaler for books.

The library management systems 10-1 to 10-3 each comprise, for example, a personal computer or the like installed in the respective libraries, and execute a process for ordering new books as well as a process related to the loan of books.

The network 11 is, for example, the Internet and allows exchange of information between the book management apparatus 12 and the library management systems 10-1 to 10-3.

Similarly, the network 13 also is the Internet and allows exchange of information between the book management apparatus 12 and the wholesaler management system 14.

The wholesaler management system 14 comprises a workstation, server machine or the like installed in a company which wholesales books, and carries out a process related to the receiving/placing of orders for books.

The following describes the operation according to the illustrated principle.

Assuming that the library management system 10-1 is operated by a librarian to make a request for order of certain books, the request is transmitted to the book management apparatus 12 through the network 11.

The book management apparatus 12 supplies the order request to the ordering information management means 12d to have the order managed thereby. Such orders are put in also from the other library management systems 10-2 and 10-3 and are stored until a predetermined term expires, and accordingly, a plurality of orders are accumulated in the ordering information management means 12d.

It is very often the case that an order for the same book is simultaneously placed from a plurality of libraries. In such cases, a discount is given on the basis of a total number of copies ordered. For example, a 10% discount is afforded for an order of 100 or more copies of the same book.

When a predetermined day has come, the ordering means 12e transmits the orders stored in the ordering information management means 12d to the wholesaler management system 14 through the network 13.

The wholesaler management system 14 arranges to deliver the ordered books to the respective libraries, and if the ordered books include a book(s) whose bibliographic information (information including title, author, publisher, etc.) is not registered in the bibliographic information management means 12b of the book management apparatus 12, the system 14 also transmits such bibliographic information to the book management apparatus 12. On receiving the bibliographic information, the book management apparatus 12 stores the received bibliographic information in the bibliographic information management means 12b.

After the books are received, a collating process is performed in the library. As the collating process is executed, information identifying the newly received books is transmitted to the book management apparatus 12 through the network 11. The book management apparatus 12 then notifies the wholesaler management system 14 that the collation has been completed and that the books have been delivered in good condition, and also correlates the bibliographic information registered in the bibliographic information management means 12b with the book stock information registered in the book stock information management means 12a.

After the collating process is thus performed and the bibliographic information is correlated with the book stock information in respect of the newly accessioned books, the books can be lent to users.

Specifically, when a book is lent to a certain user, information identifying the library, information identifying the user who borrows the book, and information identifying the book are entered, so that the loan information management means 12c registers such items of information in association with the individual libraries for loan management.

As described above, the book management apparatus 12 of the present invention is capable of collective management of the bibliographic information, book stock information and loan information about the books possessed by a plurality of libraries, whereby the loads on the library management systems 10-1 to 10-3 installed in the respective libraries can be lightened. Consequently, only a simplified machine may be provided in each library, thus making it possible to cut down the costs of the overall system.

Also, book orders are gathered from a plurality of libraries so that books can be ordered in bulk, and this bulk order serves to reduce the delivery costs.

Further, the bibliographic information is directly transmitted from the wholesaler management system 14 to the book management apparatus 12 so that the information may be collectively managed by the bibliographic information management means 12b, and after the collating process is performed with the library management systems 10-1 to 10-3, the bibliographic information is correlated with the book stock information, whereby the books can be made open to access at an early time.

In the example described above, the bibliographic information of only those books, among the ordered books, whose bibliographic information is not registered in the bibliographic information management means 12b is downloaded from the wholesaler management system 14. Alternatively, when new books are published, their bibliographic information may be collectively downloaded from the wholesaler management system 14 to the bibliographic information management means 12b.

The embodiment of the present invention will be now described.

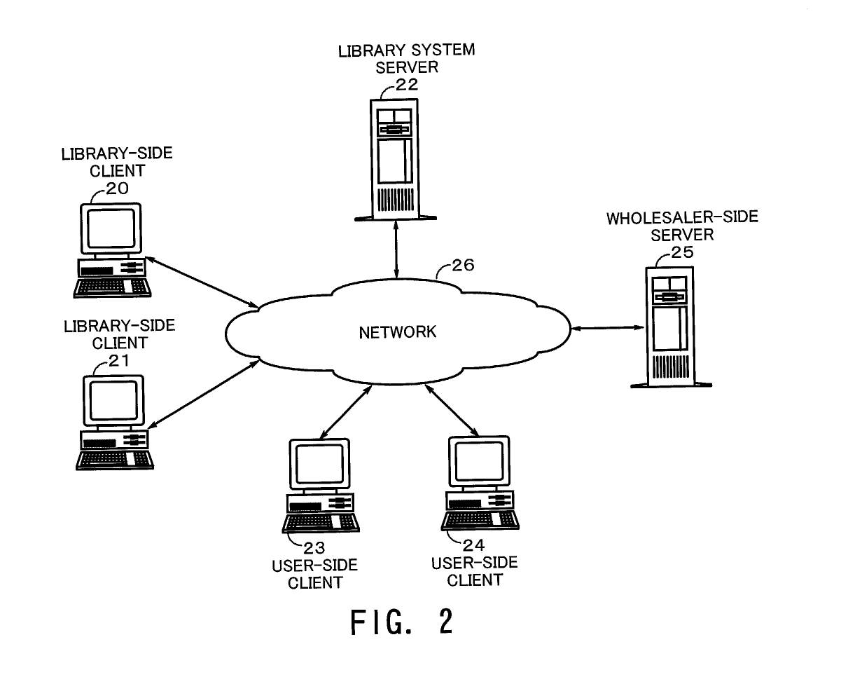

FIG. 2 shows an exemplary configuration according to the embodiment of the present invention. In the figure, library-side clients 20, 21 each comprise, for example, a personal computer installed in a library, and perform processes related to the loan of books and the ordering of new books.

A library system server 22 comprises a mainframe or the like, and manages the loan of books owned by the individual libraries, as well as the ordering.

User-side clients 23, 24 each comprise a personal computer, for example, and are allowed to access the library system server 22 to obtain desired information.

A wholesaler-side server 25, which is owned by a book wholesale company and comprises a mainframe or the like, performs a process related to the receiving/placing of book orders. Also, when new books are published, the server 25 supplies bibliographic information on these books to the library system server 22.

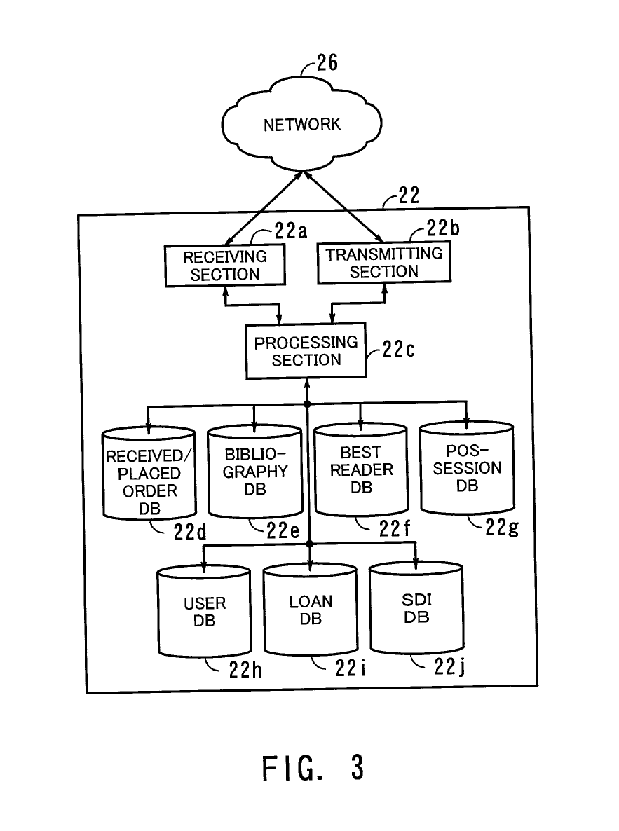

FIG. 3 shows in detail an exemplary configuration of the library system server 22. As shown in the figure, the library system server 22 comprises a receiving section 22a, a transmitting section 22b, a processing section 22c, a received/placed order DB (Data Base) 22d, a bibliography DB 22e, a best reader DB 22f, a possession DB 22g, a user DB 22h, a loan DB 22i, and an SDI (Selective Dissemination of Information) DB 22j.

The receiving section 22a receives information transmitted thereto from the library-side clients 20, 21, the user-side clients 23, 24 and the wholesaler-side server 25 over a network 26.

The transmitting section 22b transmits information to the library-side clients 20, 21, the user-side clients 23, 24 and the wholesaler-side server 25 over the network 26.

The processing section 22c manages the databases and also performs processes in compliance with requests from other machines.

The received/placed order DB 22d manages information about ordering of books, and the bibliography DB 22e manages bibliographic information which is attribute information on books. The best reader DB 22f manages information about frequently read books, created by reference to the loan DB 22i etc. The possession DB 22g manages information about the books possessed by the individual libraries, and the user DB 22h manages information about users (library users). The loan DB 22i manages information about the loan of books in the individual libraries, and the SDI DB 22j registers SDI keywords (described in detail later) requested from users.

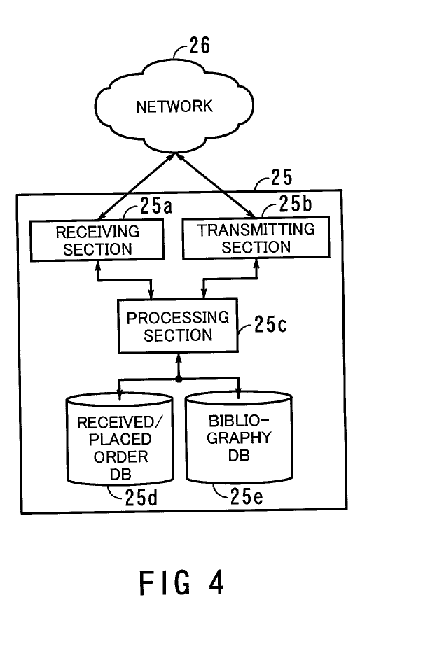

FIG. 4 shows in detail an exemplary configuration of the wholesaler-side server 25. As shown in the figure, the wholesaler-side server 25 comprises a receiving section 25a, a transmitting section 25b, a processing section 25c, a received/placed order DB 25d, and a bibliography DB 25e.

The receiving section 25a receives information transmitted thereto from the library system server 22 over the network 26.

The transmitting section 25b transmits information to the library system server 22 over the network 26.

The processing section 25c manages the databases and also carries out processes in compliance with requests from other machines.

The received/placed order DB 25d manages information about book orders transmitted from the library-side clients 20, 21. The bibliography DB 25e manages bibliographic information which is attribute information on books.

Operation of the above embodiment will be now described.

First, operation performed when new books are ordered will be described. In the following description, it is assumed by way of example that the library-side client 20 places an order for new books.

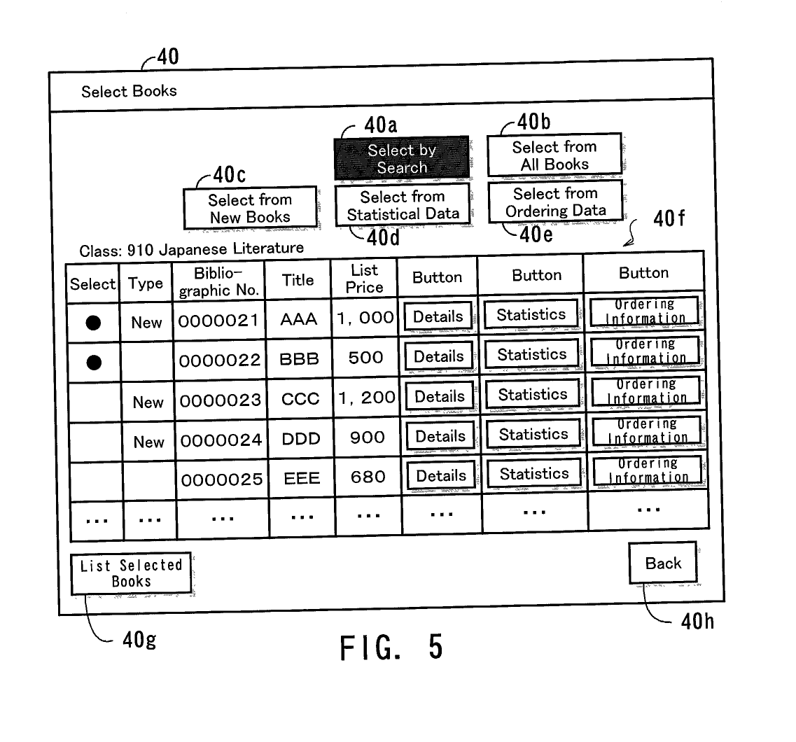

The library-side client 20 is operated to start a book selection screen which allows selection of books to be ordered, whereupon a screen 40 as shown in FIG. 5 is displayed at the display device.

In the illustrated example, buttons 40a to 40e each for specifying a method of narrowing down target books are shown below the title “Select Books”. The button 40a is operated when selecting books from among those searched by a certain keyword. The button 40b is operated when selecting books from all books, and the button 40c is operated when selecting books from newly published books. The button 40d is operated when selecting books by making reference to statistical data obtained by performing statistical processing on data about the books lent in the past. The button 40e is operated when selecting books by making reference to data about the books ordered in the past.

If the button 40a on the displayed screen is operated and “Japanese literature” is entered as a keyword, the library-side client 20 accesses the library system server 22 through the network 26 and retrieves matching data from the bibliography DB 22e.

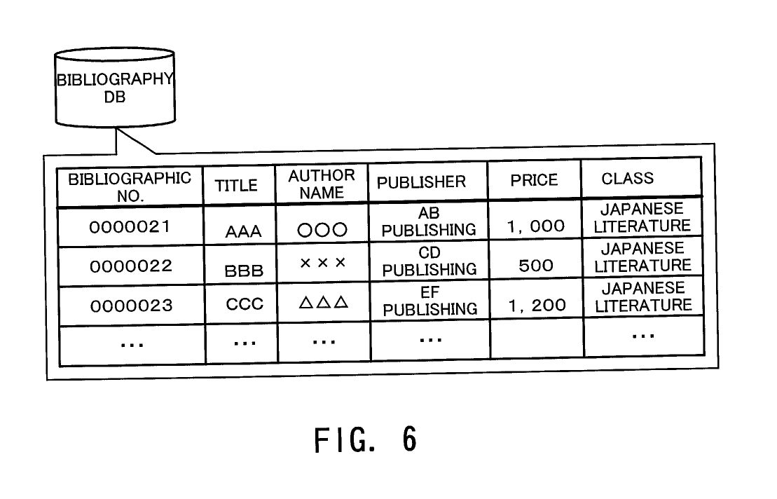

FIG. 6 shows an example of data stored in the bibliography DB 22e. In the example illustrated in the figure, bibliographic data comprises bibliographic number, title, author name, publisher, price, and class. “Bibliographic No.” is a number uniquely assigned to each book. “Title”, “Author Name”, “Publisher” and “Price” respectively indicate the title, author's name, publishing company and price of the book. “Class” denotes the genre of the book. In the bibliography DB 22e, bibliographic information about all books handled by the wholesaler-side server 25 is registered. Accordingly, in response to the search request mentioned above, bibliographic information about books matching the request among those handled by the wholesaler is acquired.

The bibliographic data acquired from the bibliography DB 22e is transmitted over the network 26 and displayed in a display area 40f of the display device associated with the library-side client 20 from which the request has been made. FIG. 5 shows a specific example.

In the illustrated example, “Select” shown near the left edge of the screen is checked to select the corresponding book. “Type” shows information as to whether the book is a new publication or some other type publication, and “Bibliographic No.” indicates the number identifying the bibliographic information of the book. “Title” shows the title of the book, and “List Price” indicates the price of the book. The button to the right of “List Price” is operated when making reference to detailed information (e.g., bibliographic information etc.). The button next to this button is operated when making reference to statistical information (e.g., loan count etc.). The rightmost button is operated when making reference to ordering information (e.g., number of copies ordered until then).

A button 40g shown in the lower left corner is operated to display a list of books selected until then. A button 40h in the lower right corner is operated to return to the immediately preceding screen.

The use of the screen makes it possible to pick out desired books from those culled by using a keyword.

When the “Select from Ordering Data” button 40e shown in FIG. 5 is operated, the process described below is performed.

On operation of the button 40e, the library-side client 20 requests the processing section 22c of the library system server 22 to search the received/placed order DB 22d for books with large numbers of orders, from among recently ordered books.

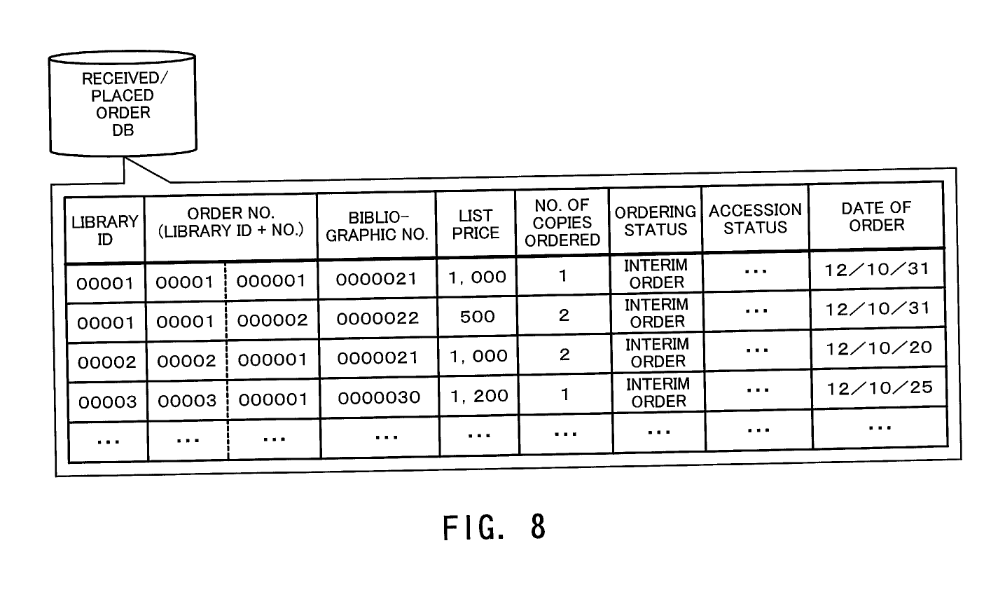

FIG. 8 shows an example of received/placed order data stored in the received/placed order DB 22d. In the example illustrated in the figure, the received/placed order data comprises library ID, order number, bibliographic number, list price, number of copies ordered, ordering status, accession status, and date of order. “Library ID” is an ID for identifying a library, and “Order No.” consists of the library ID and a six-digit number indicating an order number. “Bibliographic No.” and “List Price” are already explained above. “No. of Copies Ordered” shows the number of copies of the book ordered, and “Ordering Status” indicates whether the status of ordering is “Interim Order” or “Firm Order”. “Accession Status” indicates whether the status of accession is “Not Accessioned” or “Accessioned”, and “Date of Order” indicates the date on which the order was placed.

The processing section 22c sums up the numbers of copies of recently ordered books, among the data stored in the received/placed order DB 22d, and specifies books with large total numbers of ordered copies. The data obtained is transmitted to the library-side client 20.

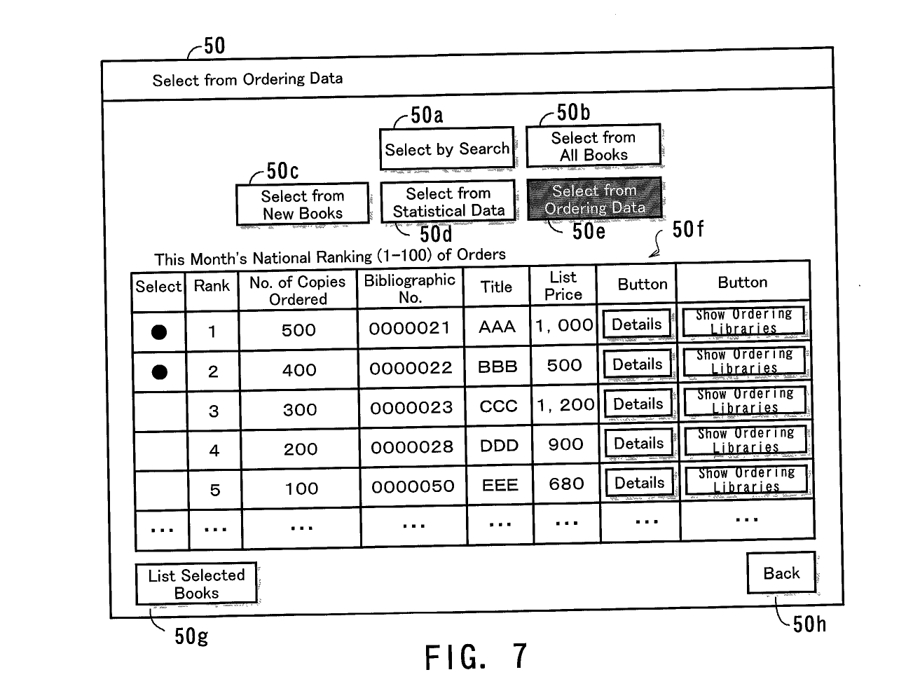

The library-side client 20 displays the received data on a screen 50 shown in FIG. 7. In the illustrated example, a list of books with large total numbers of ordered copies is shown in a display area 50f. Specifically, “Select” provides the same function as stated above, and “Rank” indicates the place of ranking in terms of the number of copies ordered. “No. of Copies Ordered” shows the total number of copies ordered. “Bibliographic No.”, “Title” and “List Price” indicate the respective items of data stated above. A “Details” button is operated to display detailed information on the book, and a “Show Ordering Libraries” button is operated to display a list of libraries which already placed orders.

Reference to the screen 50 permits selection of books from a displayed list of books with large numbers of ordered copies, so to speak, with high utility values.

When the “Select from Statistical Data” button 50d is operated in the screen 50 shown in FIG. 7, the process described below is performed.

On operation of the button 50d, the library-side client 20 requests the processing section 22c of the library system server 22 to search the best reader DB 22f for books with large loan counts.

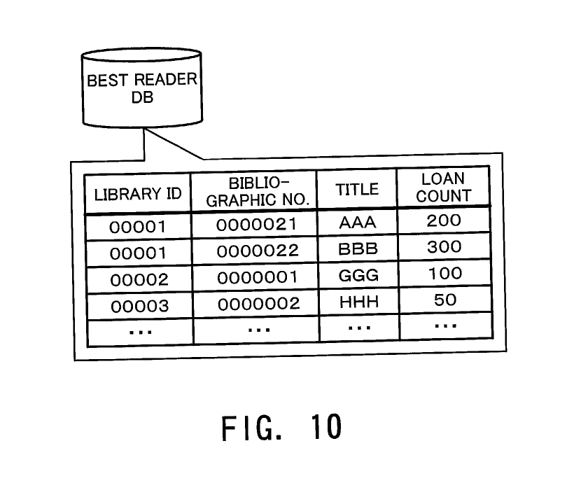

FIG. 10 shows an example of data stored in the best reader DB 22f. In the example shown in the figure, best reader data comprises library ID, bibliographic number, title, and loan count. “Library ID”, “Bibliographic No.” and “Title” are the same as those explained above. “Loan Count” indicates the number of times the library concerned has lent the book.

The processing section 22c performs a summing process on data about identical books, among the data stored in the best reader DB 22f, to calculate total loan counts of the individual books.

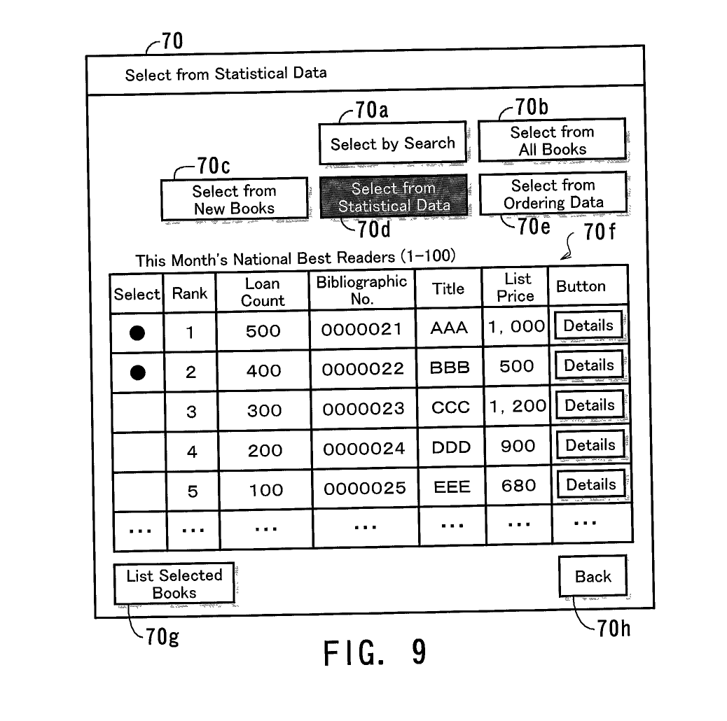

The loan counts of the individual books obtained in this manner are transmitted to the library-side client 20 and displayed in a display area 70f shown in FIG. 9. In the illustrated example, a list of books with large loan counts is displayed. In the figure, “Select”, “Rank”, “Bibliographic No.”, “Title”, “List Price” and “Button” are identical with those stated above. “Loan Count” indicates a sum total of the counts of loan of the book in all libraries.

Reference to the screen 70 permits selection of target books from the books with large loan counts.

When the “Select from New Books” button 70c is operated in the screen 70 shown in FIG. 9, the process described below is executed.

On operation of the button 70c, the library-side client 20 requests the processing section 22c of the library system server 22 to search the bibliography DB 22e for data about newly published books. The data about newly published books is automatically transmitted from the wholesaler-side server 25 and registered in the library system server 22.

Consequently, the processing section 22c acquires the data on newly published books from the bibliography DB shown in FIG. 6, and transmits the acquired data to the library-side client 20 over the network 26.

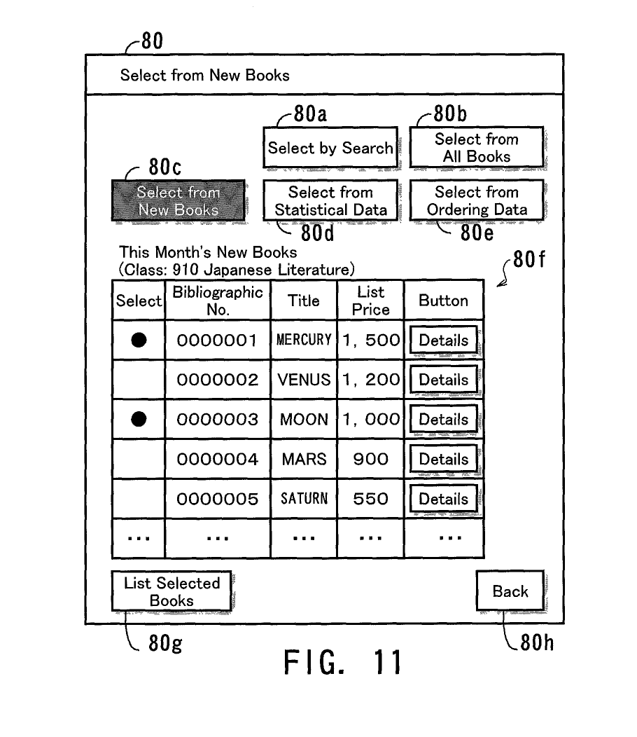

The library-side client 20 displays the acquired data in a display area 80f of a screen 80 shown in FIG. 11. In the illustrated example, information about newly published books is displayed in list form. “Select”, “Bibliographic No.”, “Title”, “List Price” and “Button” are the same as those stated above.

Reference to the screen 80 permits selection of desired books from newly published books.

After books are selected in any of the book selection screens explained above, the books are ordered in the manner described below. In the screen 80 shown in FIG. 11, for example, a “List Selected Books” button 80g is operated, whereupon the library-side client 20 transmits the bibliographic number of the selected book to the library system server 22, to inquire about an estimated purchasing price of the book.

The processing section 22c of the library system server 22 calculates the number of copies of the book ordered during the period after the last closing day through to the present, stored in the received/placed order DB 22d. For example, the processing section 22c calculates the number of copies of the book with the bibliographic number “0000001” ordered during the period from the last closing day (e.g., end of the previous month) up to the present, and obtains “125” as a result.

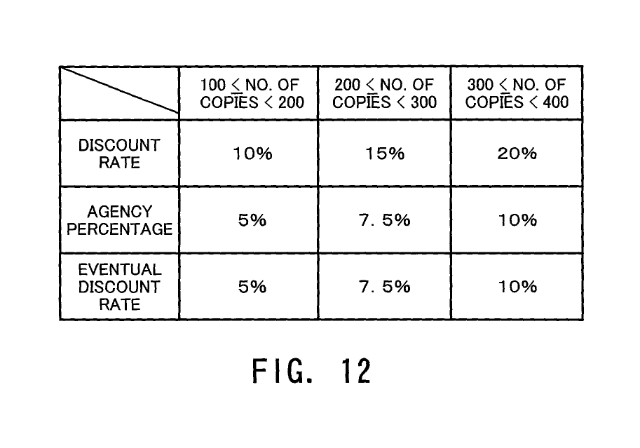

The processing section 22c then checks the number of ordered copies obtained in this manner against a table shown in FIG. 12, to derive a discount rate. The table of FIG. 12 indicates the correspondence of the number of copies ordered to applicable discount rate and agency percentage. For example, if the number of copies ordered is greater than or equal to “100” and at the same time is less than “200”, the discount rate is 10% while the agency percentage is 5%, so that the eventual discount rate is 5%. In this example, since 125 copies have been ordered, the eventual discount rate is found to be 5%. The processing section 22c also performs the same process on the book with the bibliographic number “0000003” and obtains an eventual discount rate of 10% for this book.

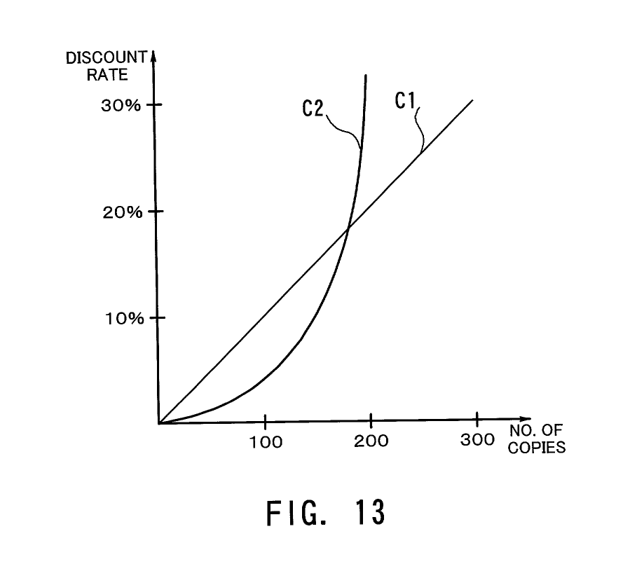

In the above example, the number of copies ordered and the discount rate are in a proportional relationship, and this relationship can be plotted as a straight line Cl shown in FIG. 13. Alternatively, the number of copies ordered and the discount rate may be in a curvilinear relationship indicated by a curve C2.

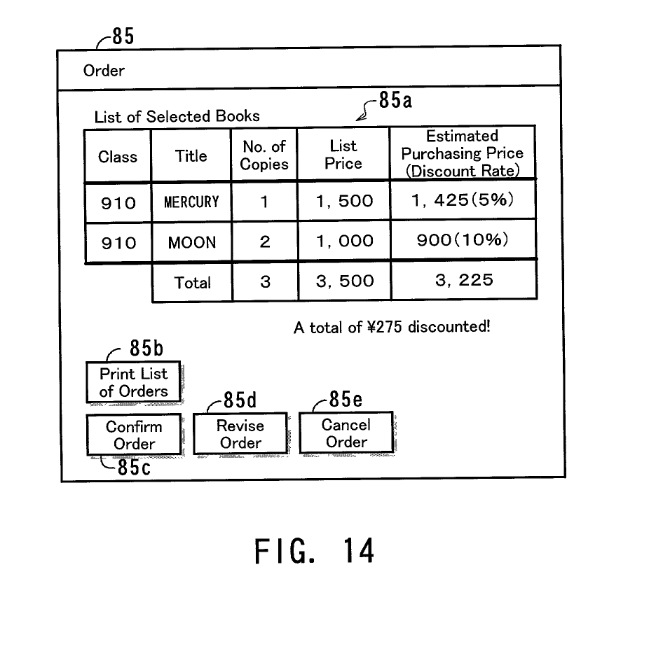

Subsequently, the processing section 22c transmits the discount rates calculated in the aforementioned manner to the library-side client 20. As a result, a screen 85 as shown in FIG. 14 is displayed at the library-side client 20.

In the illustrated example, a list of the selected books is shown in a display area 85a. Specifically, the class, title, number of copies, list price and estimated purchasing price of each selected book are displayed. “Class” indicates the category to which the book belongs, and “Title” indicates the title of the book. “No. of Copies” indicates the number of copies ordered, and “List Price” indicates the regular selling price of the book. “Estimated Purchasing Price” shows the price obtained as a result of the reduction by the aforementioned “Eventual Discount Rate”.

A button 85b shown below the display area 85a is operated to print a list of the books to be ordered. A button 85c is operated to confirm the order. A button 85d is operated to revise an order already put in, and a button 85e is operated to cancel an already placed order.

The discount rates are checked on the screen 85 and the button 85c is operated to confirm the order, whereupon the order for these books is transmitted to the library system server 22 over the network 26.

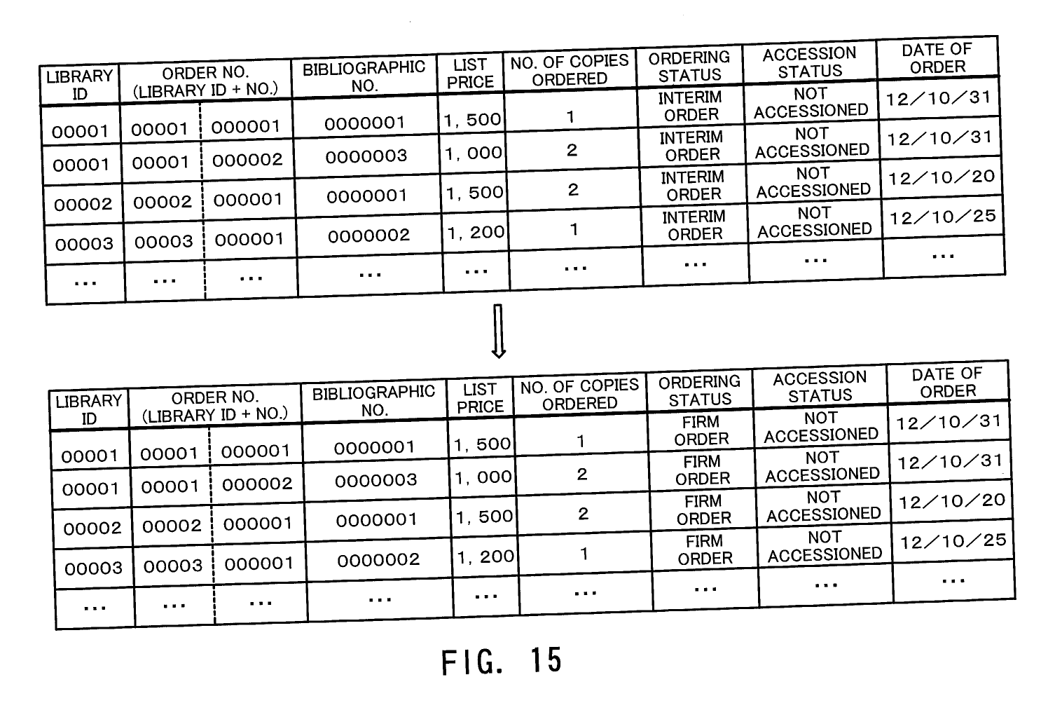

The library system server 22 stores the received order in the received/placed order DB 22d. On the day for closing orders, the numbers of ordered copies of books with identical bibliographic numbers are summed up by looking up the ordering data transmitted from the individual libraries and accumulated in the received/placed order DB 22d, and eventual discount rates are calculated based on the respective numbers of copies ordered. Subsequently, the orders are placed in a lump with the wholesaler-side server 25 at the eventual discount rates thus calculated. At this time, the processing section 22c changes the “Ordering Status” of the ordering data stored in the received/placed order DB 22d from “Interim Order” to “Firm Order”, as shown in FIG. 15.

On completion of the change of the received/placed order DB 22d, the processing section 22c creates electronic mail messages notifying the acceptance of orders and the eventual purchasing prices, and transmits the same to the respective libraries from which the orders have been received.

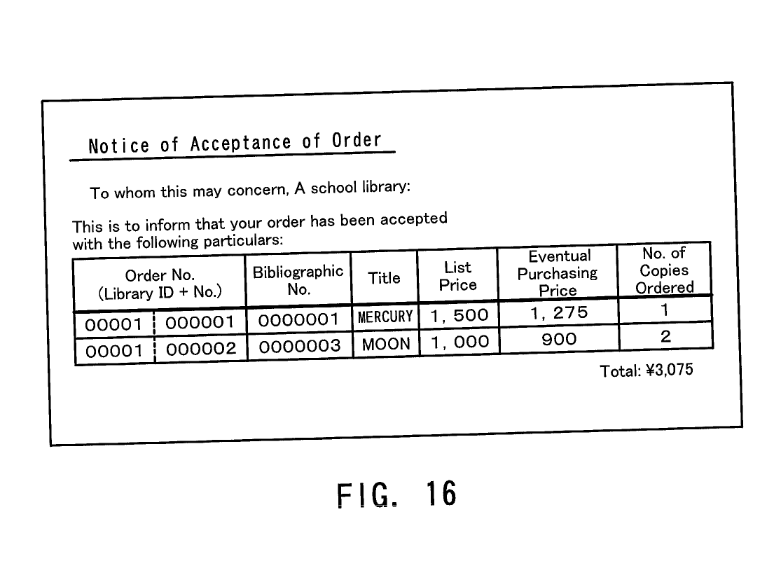

FIG. 16 shows an example of the electronic mail message transmitted at this time. In the illustrated example, details of the order are described following the title “Notice of Acceptance of Order”. Specifically, the order number, the bibliographic number, the title, the list price, the eventual purchasing price, and the number of copies ordered are shown in list form. “Eventual Purchasing Price” indicates the price reflecting the eventual discount rate calculated based on the number of copies of the book ordered by the closing day.

Such electronic mail allows the librarian at each library to ascertain the kinds of books ordered as well as the eventual prices.

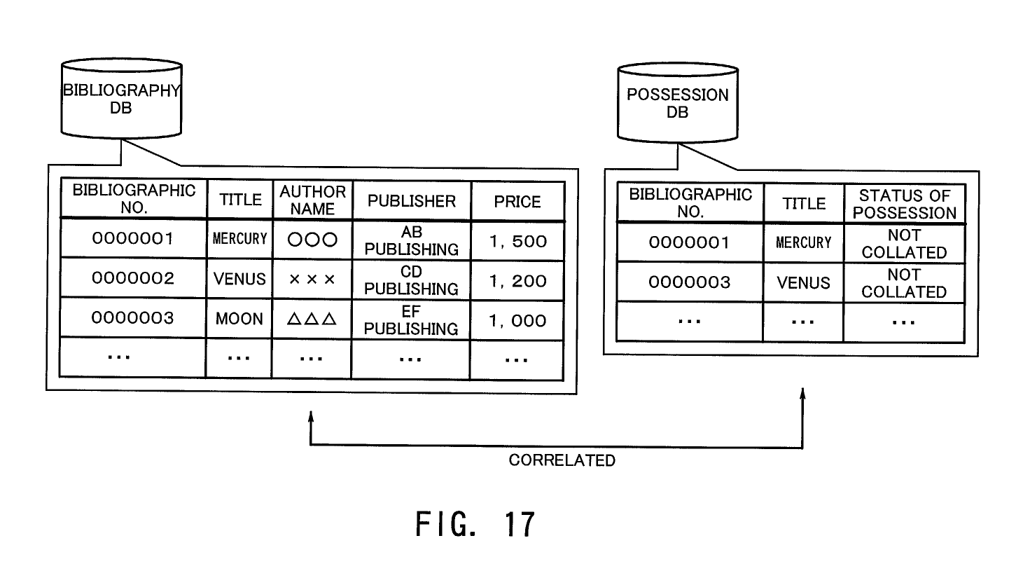

Subsequently, the processing section 22c of the library system server 22 classifies the ordered books according to libraries and stores the classified data in the possession DB 22g, so that the bibliography DB 22e and the possession DB 22g are correlated with each other, as shown in FIG. 17. At this stage, a collating process is not yet performed, and accordingly, “Status of Possession” in the possession DB 22g is set to “Not Collated”.

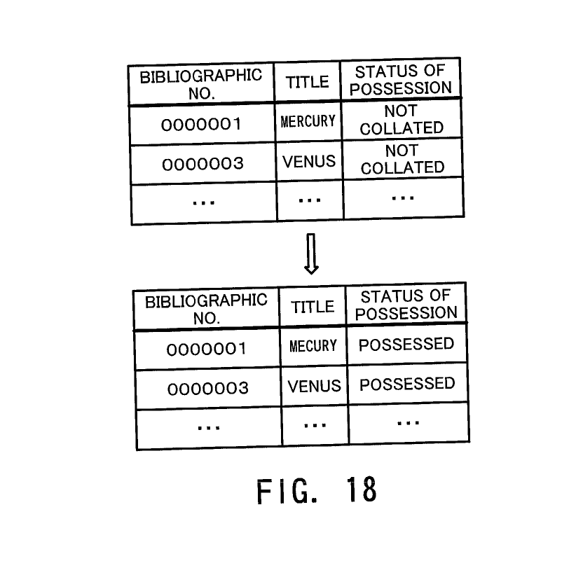

Then, after the ordered books are delivered to a recipient library, an collating operation is performed. In the collating operation, a barcode printed on each book (ISBN (International Standard Book Number) and a possession barcode affixed to or to be affixed to the book) is read with a barcode reader and transmitted to the library system server 22. As a result, “Status of Possession” in the possession DB 22g is rewritten from “Not Collated” to “Possessed”, as shown in FIG. 18, so that the books are made open to access and can be lent thereafter. Also, the wholesaler-side server 25 is notified that the collation has been completed, and therefore, it rewrites the corresponding items in the received/placed order DB 25d to indicate completion of the collating process.

Subsequently, the library system server 22 notifies the wholesaler-side server 25 of the results of collation. As a consequence, in the wholesaler-side server 25, the contents of the received/placed order DB 25d are rewritten by the processing section 25c, and this completes the order receiving/placing process.

According to the process described above, the importance of previously published books or newly published books can be judged from various angles, so that books meeting users' needs can be selected.

Also, orders from a plurality of libraries are placed in a lump, and therefore, books can be purchased at prices reduced in accordance with the numbers of copies ordered.

After ordering, books are automatically registered in the possession DB 22g as their barcodes are read in. This saves the librarian labor-consuming manual work for the registration and also permits the books to be immediately made open to access for lending.

After books are collated, the wholesaler-side server 25 is automatically notified that the books have been delivered in good condition. This saves the labor of sending such notification to the wholesaler.

Also, when new books have been published, their bibliographic data is automatically transmitted from the wholesaler-side server 25 to be registered in the library system server 22 so that information about new publications can be referred to without delay.

The following is a description of an embodiment whereby the user-side clients 23, 24 are allowed to search the possession data registered in the library system server 22.

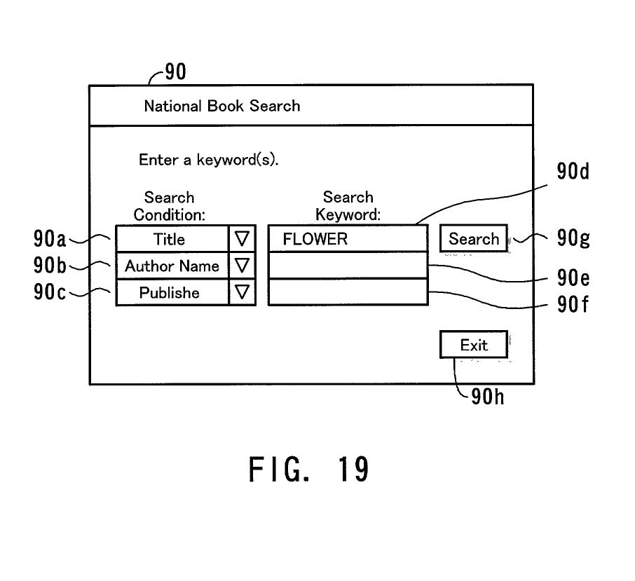

FIG. 19 shows an exemplary screen displayed at the user-side client 23, 24 when the data registered in the possession DB 22g owned by the library system server 22 is to be searched. In the illustrated example, a screen 90 shows three textboxes 90d to 90f for entering search keywords, and textboxes 90a to 90c allowing selection of attributes with respect to which corresponding search keywords are entered in the respective textboxes 90d to 90f. On the right side of the screen 90, a button 90g is shown which is operated to perform a search by an entered search keyword(s), and a button 90h for terminating the display of the screen 90 is shown below the button 90g.

In the screen 90, for example, title is selected in the textbox 90a as an attribute, the search keyword “FLOWER” is entered in the textbox 90d to the right of the textbox 90a, and the button 90g is operated, whereupon the data entered in the screen 90 is transmitted to the library system server 22 over the network 26.

The processing section 22c of the library system server 22 searches the bibliography DB 22e and the possession DB 22g for books with titles including the keyword corresponding to the received data. If, as a result, matching books are found, the corresponding bibliographic data is retrieved from the bibliography DB 22e and transmitted to the user-side client from which the search request has been received. At the user-side client, the books matching the sent keyword and libraries possessing the books are displayed in list form.

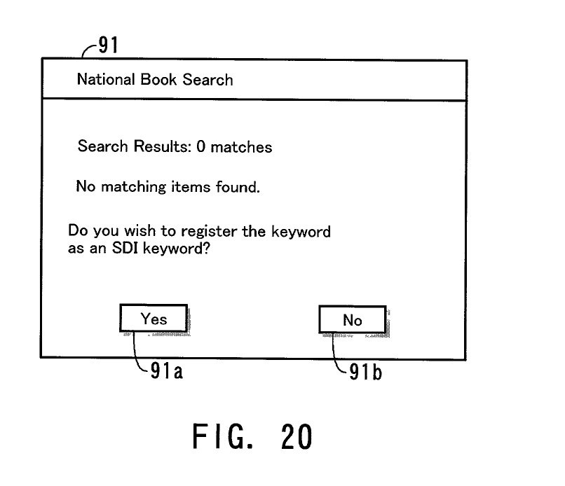

If no matching data is found, a screen shown in FIG. 20 is displayed at the display device of the user-side client which has requested the search.

In the illustrated example, a screen 91 entitled “National Book Search” is displayed, and a display area thereof includes a message that the search results show “0” matches as well as a message inquiring whether to register the keyword as an SDI keyword. SDI denotes a service which allows users to register keywords of their interest so that lists of material matching the keywords among contents of information on newly published books, foreign magazines, etc. may be delivered to the respective users' mail addresses.

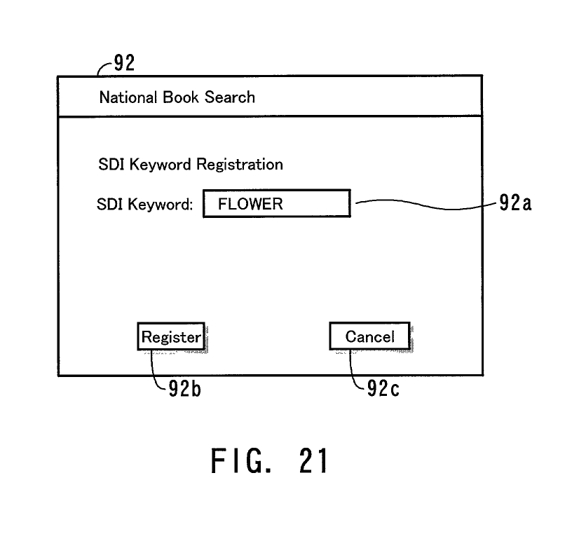

If, in the screen 91, a button 91a is operated, a screen 92 for registering an SDI keyword, shown in FIG. 21, is displayed. In the screen 92 are displayed a textbox 92a for entering an SDI keyword, a button 92b operated to register the keyword, and a button 92c operated to cancel registration.

If, in the screen 92 shown in FIG. 21, the SDI keyword “FLOWER” is entered in the textbox 92a and the button 92b is operated, the entered keyword is transmitted to the library system server 22.

The processing section 22c of the library system server 22 registers the received keyword in the SDI DB 22j, along with information identifying the user who has requested the registration.

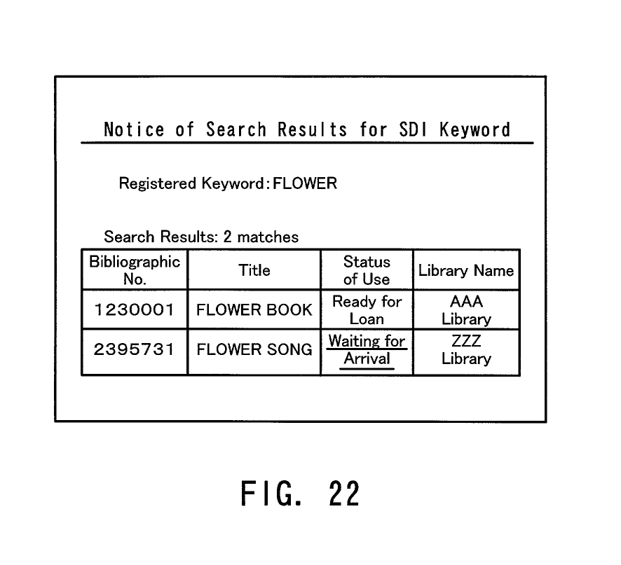

When information about newly published books has been downloaded from the wholesaler-side server 25, the processing section 22c searches the bibliography DB 22e and the possession DB 22g to determine whether books matching the SDI keyword have been newly registered or not. If, as a result, it is found that matching books have been registered, an electronic mail message as shown in FIG. 22 is transmitted to the user-side client from which the request has been received.

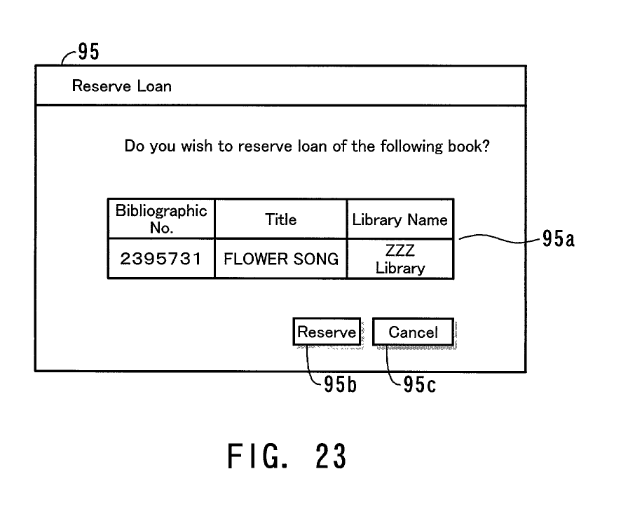

The electronic mail message includes the title “Notice of Search Results for SDI Keyword”, and the results of search by the registered keyword “FLOWER” are shown below the title. Specifically, the search results show information about books with the bibliographic numbers “1230001” and “2395731”; that is, the titles of these books, the status of use, and the names of the libraries possessing the respective books are displayed. In the electronic mail message, the status of use of the second display item “FLOWER SONG” is set to “Waiting for Arrival”. Namely, this book has been ordered but not collated yet. In conventional systems, it is not possible to make a reservation for the loan of an uncollated book, but in this embodiment, loan of such a book can be reserved on a screen as shown in FIG. 23, which is displayed as soon as the hot text “Waiting for Arrival” is clicked.

In the illustrated example, a screen 95 entitled “Reserve Loan” is displayed, and information about the book for which loan is to be reserved is shown in a display area 95a. In the lower right part of the display area are shown a button 95b which is operated to reserve loan, and a button 95c which is operated to exit without making reservation. If, in the screen 95, the button 95b is operated, a reservation request for this book is transmitted to the library system server 22 and the status of possession in the possession DB 22g associated with a ZZZ library is changed from “Not Collated” to, for example, “Not Collated—Loan Reserved”. After the desired book is delivered to the ZZZ library and collation thereof is completed, an electronic mail message notifying the arrival of the book is transmitted to the user who has made the reservation.

The above example describes the process of reserving the loan of an uncollated book. Needless to say, a process for reserving the loan of a book which has been collated but is currently on loan, as well as a process for reserving the loan of a book which has been collated and is ready for lending may be carried out.

The use of the service described above enables users to learn the arrival of their desired books and also to reserve the loan of uncollated books, not to speak of collated books, whereby the convenience of users can be improved.

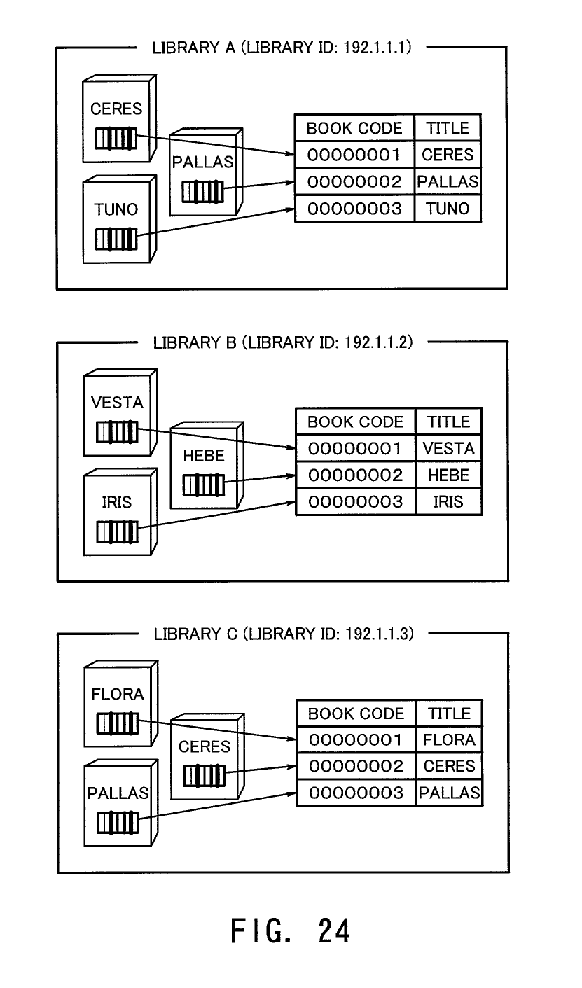

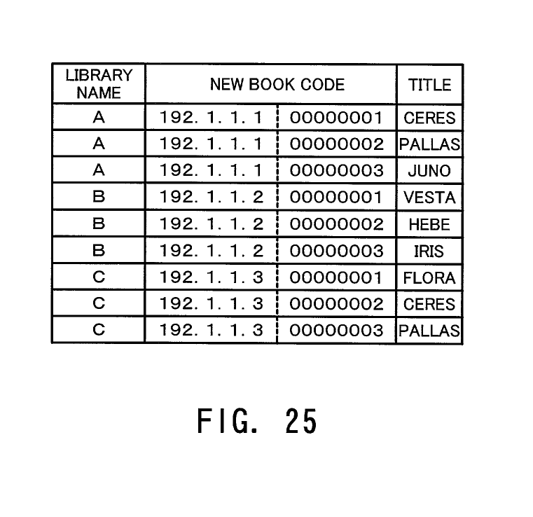

Referring now to FIGS. 24 and 25, a procedure which is followed to allow an existing library to newly join the service provided by the aforementioned embodiment will be described.

Let it be assumed, by way of example, that libraries A to C adopting respective unique book codes newly join the service.

In such cases, the book codes employed in different libraries presumably overlap with one another, and accordingly, some suitable measures need to be taken for the purpose of collective management of the data. In this embodiment, an IP (Internet Protocol) address which each library owns is adopted as a code for identifying the library, and the combination of the IP address and the existing book code is used as a new book code, as shown in FIG. 25.

For example, a book owned by the library A and having the book code “00000001” and the title “CERES”, as shown in FIG. 24, is assigned a new book code which is the combination of the IP address “192.1.1.1” of this library A and the existing book code “00000001”.

By thus using IP addresses as codes for identifying individual libraries, it is possible to easily integrate the possession data even in cases where the libraries employ book codes overlapping with one another. Consequently, when a library joins the service provided by the embodiment, it is unnecessary for the library to introduce a new book code and affix again barcodes to books.

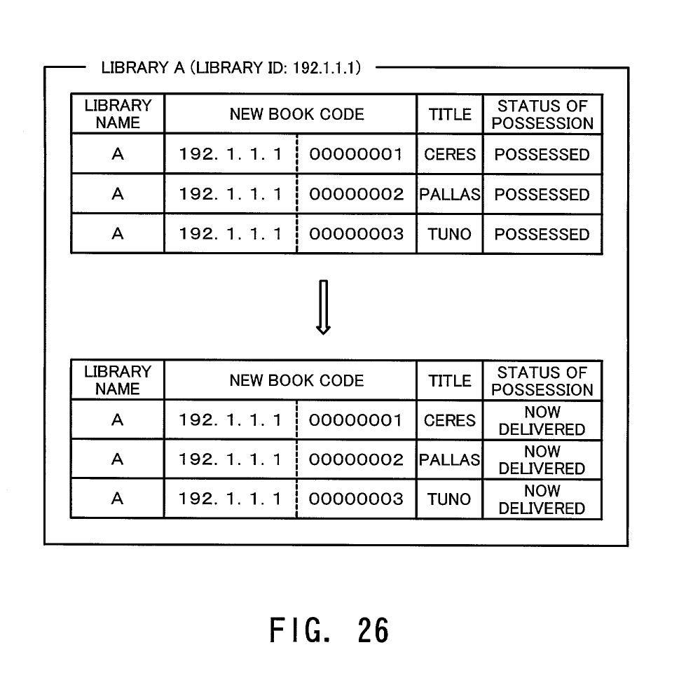

Referring now to FIGS. 26 to 30, interlibrary operations will be described.

In the present embodiment, books possessed by a plurality of libraries are collectively managed, and accordingly, users can make reference to the book stock information of libraries located in administrative districts other than those where they live. As a consequence, users naturally wish to borrow books also from such libraries.

Conventionally, when borrowing a book from a library in a different administrative district, the user must take the trouble to go to the library or request a library in the administrative district where he/she lives to have the desired book sent from the library. In such cases, at the library in the administrative district where the user lives, the borrowed book needs to be registered in the database, and when the book is returned to the library from which the book has been borrowed, the data registered in the database needs to be deleted, thus requiring complicated work.

In this embodiment, interlibrary operations can be performed such that a library which borrows books is not required to register/delete data in/from its database.

The following describes the case where the library A lends three books with the titles “CERES”, “PALLAS” and “JUNO” to the library B.

First, the library A, which is the lender library, follows the necessary procedure for lending the three books to the library B. As a result, the status of possession of the three books stored in the possession DB 22g in association with the library A is changed from “Possessed” to “Now Delivered”, as shown in FIG. 26.

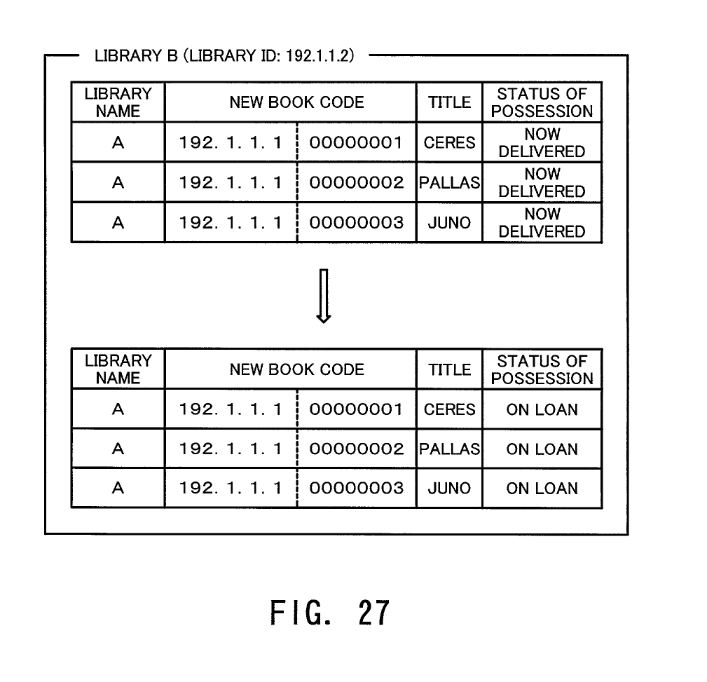

On receiving the three books from the library A, the library B performs an accessioning process (process of reading with a barcode reader the barcodes affixed to the three books, etc.). As a result, the status of possession of the three books stored in the possession DB 22g of the library system server 22 in association with the library A is changed from “Now Delivered” to “On Loan”, as shown in FIG. 27. Namely, the library B updates the possession data of the library A.

When the books are to be lent to users, the book codes affixed to the books, the IP address of the library A, and user codes of the users are entered from the library-side client installed in the library B. As a result, these items of data are transmitted to the library system server 22 and stored in an interlibrary loan data area reserved in the loan DB 22i.

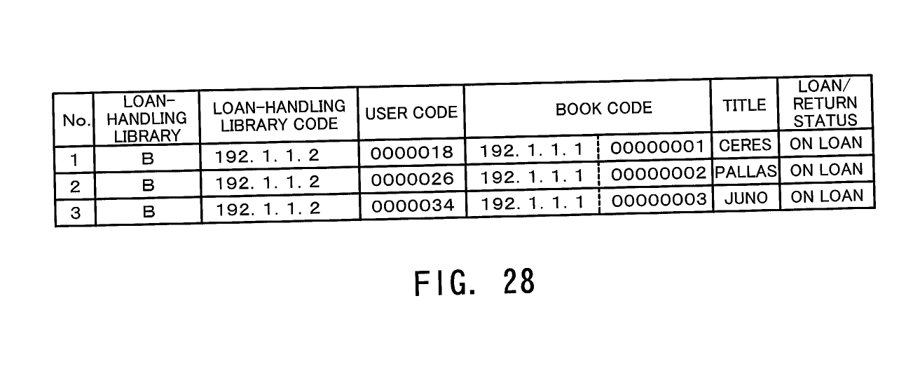

FIG. 28 shows an example of data stored in the interlibrary loan data area. In the illustrated example, interlibrary loan data comprises reference number (No.), loan-handling library, loan-handling library code, user code, book code, title, and loan/return status. “Loan-handling Library” denotes the library which performed the lending process and is the library B in this example. “Loan-handling Library Code” is the IP address of the library which performed the lending process, and “User Code” is an ID for identifying the user. “Book Code” denotes an identification code assigned to the book, and in this example, is the book code used in the library A, that is, the IP address of the library A plus the book code corresponding to the internal identification code of the library A. “Title” denotes the title of the book, and “Loan/return Status” indicates whether the book is on loan or has been returned.

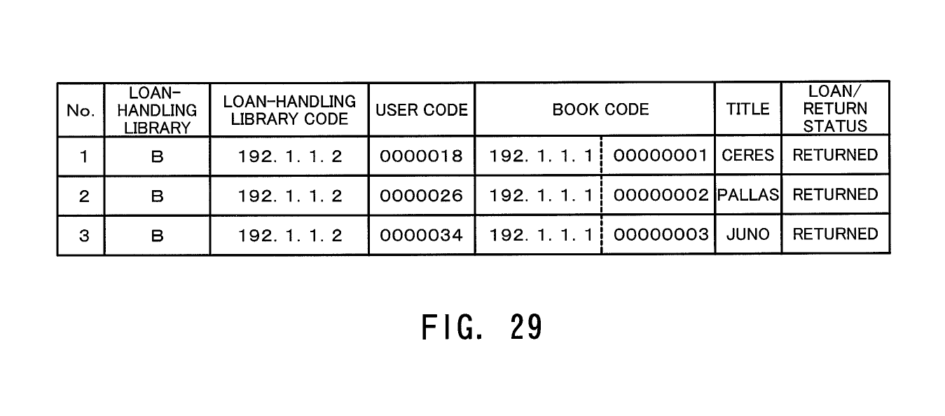

When the books have been returned from the users to the library B, the book codes recorded in the barcodes affixed to the books and the IP address of the library A are entered, whereupon these items of data are transmitted to the library system server 22 and the processing section 22c changes the loan/return status in the previously registered interlibrary loan data from “On Loan” to “Returned”, as shown in FIG. 29. The library B then returns the books to the library A.

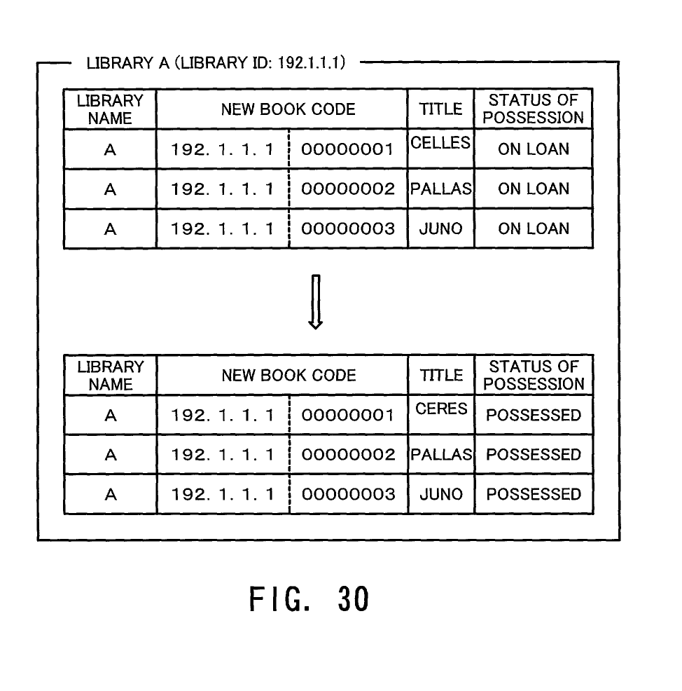

On arrival of the books, the library A performs an accessioning process. As a result, the book data about the returned books is transmitted to the library system server 22 and the processing section 22c changes the status of possession of these books, registered in the possession DB 22g in association with the library A, from “On Loan” to “Possessed”, as shown in FIG. 30.

The books can thereafter be lent to users.

The above process permits the same book code to be used where the library B borrows books owned by the library A. Accordingly, registration of books and deletion of registered data are unnecessary, making it possible to promote the exchanges of books between libraries and also to improve the convenience of users.

Exemplary processes performed in the above embodiment will be now described with reference to flowcharts.

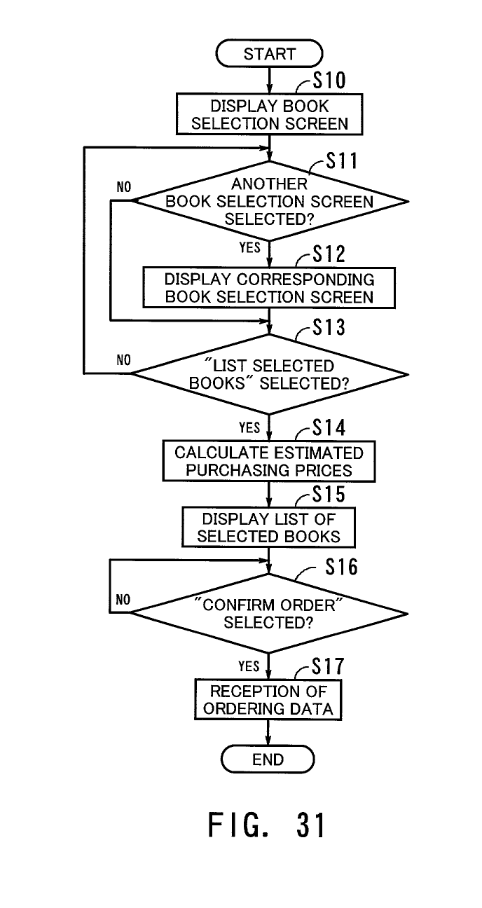

FIG. 31 shows an exemplary process executed by the library system server 22 when the library-side client 20, 21 orders books on the book selection screen. Upon start of the process shown in the flowchart, the following steps are executed.

[S10] The processing section 22c of the library system server 22 transmits, for example, the book selection screen shown in FIG. 5, to a library-side client from which a request has been received, so that the screen is displayed at the client.

[S11] If, in the book selection screen, another book selection screen has been selected (any of the buttons 40a to 40e has been operated), the processing section 22c executes Step S12; otherwise it executes Step S13.

[S12] The processing section 22c transmits the corresponding selection screen to the library-side client from which the request has been received, so that the screen is displayed at the client.

[S13] The processing section 22c determines whether or not the “List Selected Books” button, for example, the button 40g in FIG. 5, has been operated. If the button has been operated, the flow proceeds to Step S14; otherwise the flow returns to Step S11 and repeats the same process.

[S14] The processing section 22c calculates estimated purchasing prices of the selected books. Specifically, the processing section 22c looks up the received/placed order DB 22d to calculate the numbers of copies of identical books ordered during the period from the preceding closing day up to the present, and also looks up the table shown in FIG. 12 to calculate the estimated purchasing prices.

[S15] The processing section 22c transmits information about the selected books to the library-side client from which the request has been received, so that a screen as shown in FIG. 14 is displayed at the client.

[S16] The processing section 22c determines whether or not the “Confirm Order” button 85c has been operated. If the button has been operated, the flow proceeds to Step S17; if not, this step is repeatedly executed.

[S17] The processing section 22c receives the confirmed ordering data from the library-side client.

According to the above process, a book selection screen is displayed at the library-side client 20, 21, and when certain books have been selected and ordered, estimated purchasing prices then applicable can be calculated and presented to the library-side client 20, 21.

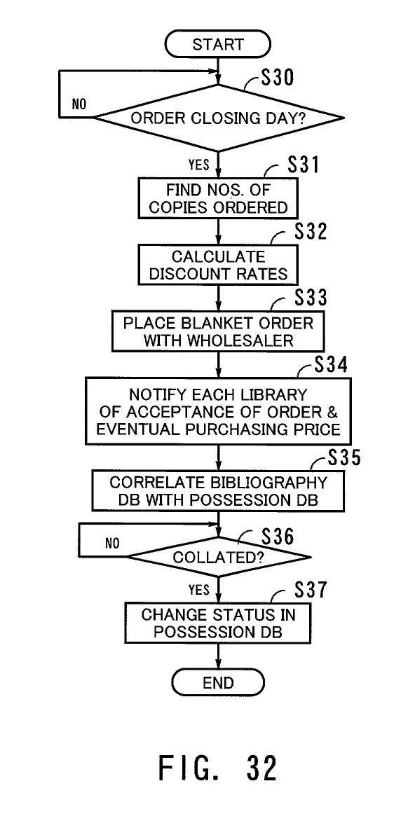

Referring now to FIG. 32, an exemplary process executed by the library system server 22 after the confirmation of order will be described.

[S30] The processing section 22c determines whether or not the order closing day has come. If the order closing day has come, the flow proceeds to Step S31; if not, this step is repeatedly executed.

[S31] The processing section 22c looks up the received/placed order DB 22d to find out, with respect to each book, the number of copies ordered during the period from the preceding closing day to the present closing day.

[S32] The processing section 22c checks the number of ordered copies of each book against the table shown in FIG. 12, to obtain a discount rate applicable to each book.

[S33] The processing section 22c places a blanket order for the books with the wholesaler. At the time of ordering, reduced prices are quoted where applicable.

[S349 The processing section 22c creates an electronic mail message as shown in FIG. 16, to notify each library of the acceptance of order and the eventual purchasing price.

[S35] The processing section 22c correlates the bibliography DB 22e with the possession DB 22g in respect of new books that have been ordered.

[S36] The processing section 22c determines whether or not the library-side client which placed an order has performed a collating process on the books delivered thereto. If the collating process has been performed, the flow proceeds to Step S37; it not, this step is repeatedly executed.

[S37] The processing section 22c changes the “Status of Possession” in the possession DB 22g from “Not Collated” to “Possessed”.

According to the above process, when the order closing day has come, eventual discount rates of individual books are calculated and also each library which has placed an order can be notified of the acceptance of the order and the eventual purchasing price. Further, the accumulated orders can be placed in a lump with the wholesaler-side server 25.

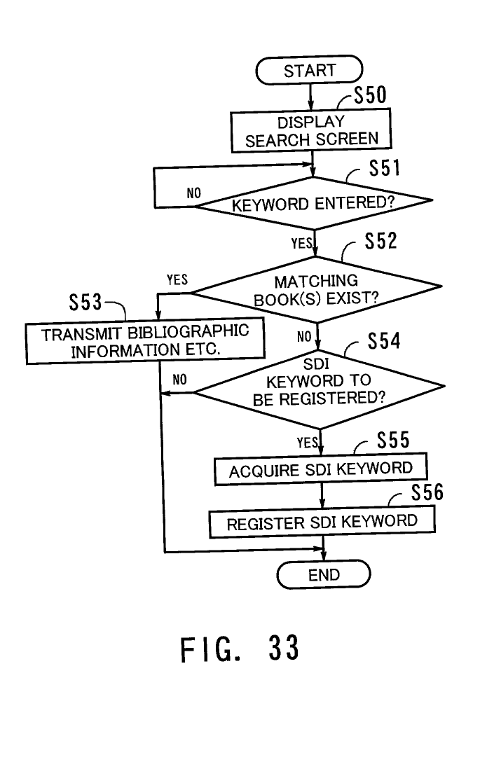

Referring now to FIG. 33, an SDI keyword registration process will be described. On start of the process shown in the flowchart, the following steps are executed.

[S50] The processing section 22c causes the search screen shown in FIG. 19 to be displayed at a user-side client which has requested a search.

[S51] The processing section 22c determines whether or not a keyword has been entered. If a keyword has been entered, the flow proceeds to Step S52; if not, this step is repeatedly executed.

[S52] The processing section 22c determines whether or not a book(s) matching the keyword are found in the possession DB 22g. If such books are found, the flow proceeds to Step S53; if not, the flow proceeds to Step S54.

[S53] The processing section 22c transmits the bibliographic information about the matching books, information about libraries possessing the books, etc., to the user-side client from which the search has been requested.

[S54] The processing section 22c inquires of the user whether or not an SDI keyword is to be registered, and causes a screen as shown in FIG. 21 to be displayed at the user-side client.

[S55] The processing section 22c acquires the SDI keyword from the user-side client.

[S56] The processing section 22c registers the SDI keyword in the SDI DB 22j.

According to the above process, in cases where a search has been requested from the user-side client 23, 24, the possession data of all libraries can be searched to provide information about books matching the keyword. Also, where no matching book information is found, the keyword can be registered as an SDI keyword.

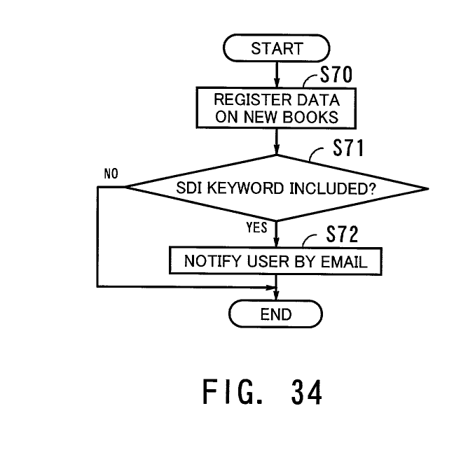

Referring now to FIG. 34, a process executed by the library system server 22 after the registration of SDI keyword will be described. This process is executed when registration of bibliographic data about new books has been requested. Upon start of the process shown in the flowchart, the following steps are executed.

[S70] The processing section 22c registers the bibliographic data on new books in the bibliography DB 22e.

[S71] The processing section 22c determines whether or not any SDI keyword is included in the newly registered bibliographic data. If any SDI keyword is included, the flow proceeds to Step S72; if not, this process is ended.

[S72] The processing section 22c sends an electronic mail message to the user-side client from which the request has been received, to notify the user of the arrival of a book(s) matching the SDI keyword, together with information on the libraries from which the books are available.

According to the above process, when new books matching an SDI keyword have been delivered to any of the libraries, a user who has registered the keyword can be notified by electronic mail or the like of the arrival of relevant books as well as the libraries possessing the books.

The above-described flowcharts shown in FIGS. 31 to 34 make it possible to perform the functions explained with reference to the embodiment of the present invention.

The functions of the above-described processes can be performed by a computer. In this case, the contents of the processing functions to be accomplished by the book management apparatus 12 and the library system server 22 are described in a program and recorded in a computer-readable recording medium so that by executing the program by a computer, the above-described processes can be performed. The computer-readable recording medium includes magnetic recording device, semiconductor memory and the like. To distribute the program to the market, the program may be stored in portable recording media such as CD-ROM (Compact Disk Read Only Memory) or floppy disk. Alternatively, the program may be stored in the storage device of a computer connected to a network and may be transferred to other computers through the network. To execute the program by a computer, the program stored in a hard disk unit or the like of the computer is loaded into the main memory and executed.

As described above, according to the present invention, a book management apparatus for managing book stocks of a plurality of libraries through a network comprises book stock information management means for managing book stock information which is information about book stocks of individual libraries, bibliographic information management means for managing bibliographic information comprising attributes of books managed by the book stock information management means, and loan information management means for managing loan information about loan of the book stocks of the individual libraries, whereby the load on librarians at the libraries can be lightened.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A book management apparatus for managing book stocks of a plurality of libraries through a network, comprising:
book stock information management means for managing book stock information which is information about book stocks of individual libraries;
bibliographic information management means for managing bibliographic information comprising attributes of books managed by said book stock information management means; and
loan information management means for managing loan information about loan of the book stocks of the individual libraries.

2. The book management apparatus according to claim 1, wherein when loan of a book is conducted between different libraries, said loan information management means enables a predetermined library to modify the loan information of another library.

3. The book management apparatus according to claim 1, further comprising ordering information management means for managing ordering information on books newly ordered from the individual libraries; and
ordering means for placing an order with a book wholesaler, based on the ordering information managed by said ordering information management means.

4. The book management apparatus according to claim 3, further comprising collation information receiving means for receiving collation information derived when a book ordered by said ordering means is accessioned by a corresponding library; and
collation information transmitting means for transmitting the collation information received by said collation information receiving means to the wholesaler.

5. The book management apparatus according to claim 1, further comprising loan reserving means for registering a book ordered by said ordering means in said book stock information management means as an uncollated book and permitting loan of the book to be reserved even if the book is not yet delivered.

6. The book management apparatus according to claim 3, wherein said ordering means places an order at a price reduced in accordance with an order quantity.

7. The book management apparatus according to claim 4, further comprising reduced price estimating means for looking up the ordering information managed by said ordering information management means, to estimate a reduced price of a book which a library is going to order.

8. The book management apparatus according to claim 3, further comprising statistical information generating means for looking up the loan information managed by said loan information management means or the ordering information managed by said ordering information management means, to generate statistical information about loan or ordering of books; and
providing means for providing the statistical information generated by said statistical information generating means to the individual libraries.

9. The book management apparatus according to claim 1, further comprising request receiving means for receiving a request from a user;
searching means, responsive to reception of a request for search for a book by said request receiving means, for searching the book stock information for information about a matching book; and
search result transmitting means for transmitting a result of search by said searching means to the user from whom the request has been received.

10. The book management apparatus according to claim 9, further comprising keyword registration means for registering a predetermined keyword if book stock information matching the book was not found by said searching means; and
newly registered information transmitting means, responsive to new registration into the book stock information of a book matching the keyword registered by said keyword registration means, for transmitting the newly registered information about the book to a user with respect to whom the keyword has been registered.

11. A book management method for managing book stocks of a plurality of libraries through a network, comprising:
a book stock information management step of managing book stock information which is information about book stocks of individual libraries;
a bibliographic information management step of managing bibliographic information comprising attributes of books managed in said book stock information management step; and
a loan information management step of managing loan information about loan of the book stocks of the individual libraries.

12. A computer-readable recording medium recording a program for causing a computer to perform a process of managing book stocks of a plurality of libraries through a network, wherein the computer is caused to function as
book stock information management means for managing book stock information which is information about book stocks of individual libraries,
bibliographic information management means for managing bibliographic information comprising attributes of books managed by the book stock information management means, and
loan information management means for managing loan information about loan of the book stocks of the individual libraries.
